(19) United States
(12) Patent Application Publication
(10) Pub. No.: US 2025/0192434 A1
(43) Pub. Date: Jun. 12, 2025

(54) ANTENNA DEVICE

(71) Applicant: AUO Corporation, Hsinchu City (TW)

(72) Inventors: Shih-Hsien Yang, Hsinchu City (TW); Chung-Hung Chen, Hsinchu City (TW); Yi-Cheng Lai, Hsinchu City (TW); Yu-Chih Wang, Hsinchu City (TW); Yi-Hui Lin, Hsinchu City (TW); Shuo-Yang Sun, Hsinchu City (TW); Zong-Long Jhang, Hsinchu City (TW)

(73) Assignee: AUO Corporation, Hsinchu City (TW)

(21) Appl. No.: 18/914,220

(22) Filed: Oct. 13, 2024

Related U.S. Application Data
(60) Provisional application No. 63/606,806, filed on Dec. 6, 2023.

(30) Foreign Application Priority Data
Jun. 27, 2024 (TW) 113123932

(51) Int. Cl. H01Q 9/04; H01Q 1/22; H01Q 1/52

(52) U.S. Cl. CPC H01Q 9/0407; H01Q 1/2283; H01Q 1/526

(57) ABSTRACT

An antenna device includes a transparent substrate and a plurality of antenna units disposed on the transparent substrate. The transparent substrate has a first surface and a second surface opposite to the first surface. A light-transmitting area is provided between adjacent antenna units. Each antenna unit includes an antenna electrode, a ground electrode, a redistribution structure, and a chip. The antenna electrode is disposed on the first surface of the transparent substrate. The ground electrode is disposed on the second surface of the transparent substrate. A width of the ground electrode in a first direction is greater than a width of the antenna electrode in a first direction. The redistribution structure is coupled to the antenna electrode. The ground electrode is located between the redistribution structure and the transparent substrate. The chip is bonded to the redistribution structure.

### CROSS-REFERENCE TO RELATED APPLICATION

This application claims the priority benefit of U.S. provisional application Ser. No. 63/606,806, filed on Dec. 6, 2023, and Taiwan application serial no. 113123932, filed on Jun. 27, 2024. The entirety of each of the above-mentioned patent applications is hereby incorporated by reference herein and made a part of this specification.

### BACKGROUND

### Technical Field

The disclosure relates to an antenna device.

### Description of Related Art

With the development of communication technology, antenna devices are used more and more widely. For example, televisions, radios, vehicles, mobile phones, etc. can all be equipped with antennas to receive and transmit various signals. Some antenna devices are integrated into a printed circuit board and formed through an electroplating process used in manufacturing the printed circuit board. However, the printed circuit board is usually light-tight and would block the user's view if mounted in a window.

### SUMMARY

The disclosure provides an antenna device, in which a light-transmitting area is provided between antenna units, thereby allowing a user to see the scene behind the antenna device through the antenna device. In addition, the design of the ground electrode may reduce the interference of external signals to the antenna electrode.

At least one embodiment of the disclosure provides an antenna device, which includes a transparent substrate and a plurality of antenna units disposed on the transparent substrate. The transparent substrate has a first surface and a second surface opposite to the first surface. A light-transmitting area is provided between adjacent antenna units. Each antenna unit includes an antenna electrode, a ground electrode, a redistribution structure, and a chip. The antenna electrode is disposed on the first surface of the transparent substrate. The ground electrode is disposed on the second surface of the transparent substrate. A width of the ground electrode in a first direction is greater than a width of the antenna electrode in a first direction. The redistribution structure is coupled to the antenna electrode. The ground electrode is located between the redistribution structure and the transparent substrate. The chip is bonded to the redistribution structure.

### BRIEF DESCRIPTION OF THE DRAWINGS

FIG. 1A is a schematic cross-sectional view of an antenna device according to an embodiment of the disclosure.

FIG. 1B is a schematic bottom view of the antenna unit of the antenna device in FIG. 1A.

FIG. 1C is a schematic top view of the ground electrode and the first antenna signal line of the antenna device in FIG. 1A.

FIG. 1D and FIG. 1E are schematic top views of the shielding structure of the antenna device in FIG. 1A and its corresponding antenna signal line.

FIG. 2 is a schematic bottom view of an antenna unit of an antenna device according to an embodiment of the disclosure.

FIG. 3 is a schematic bottom view of an antenna unit of an antenna device according to an embodiment of the disclosure.

FIG. 4 is a schematic bottom view of an antenna device according to an embodiment of the disclosure.

FIG. 5A is a schematic cross-sectional view of an antenna device according to an embodiment of the disclosure.

FIG. 5B is a schematic top view of the shielding structure of the antenna device in FIG. 5A and its corresponding driving electrode.

FIG. 6A and FIG. 6B are schematic cross-sectional views of an antenna device along different sections according to an embodiment of the disclosure.

FIG. 6C is a schematic top view of the antenna device in FIG. 6A and FIG. 6B.

FIG. 7A is a S11 parameter curve graph of some antenna devices according to an embodiment of the disclosure.

FIG. 7B is a S21 parameter curve graph of some antenna devices according to an embodiment of the disclosure.

### DESCRIPTION OF THE EMBODIMENTS

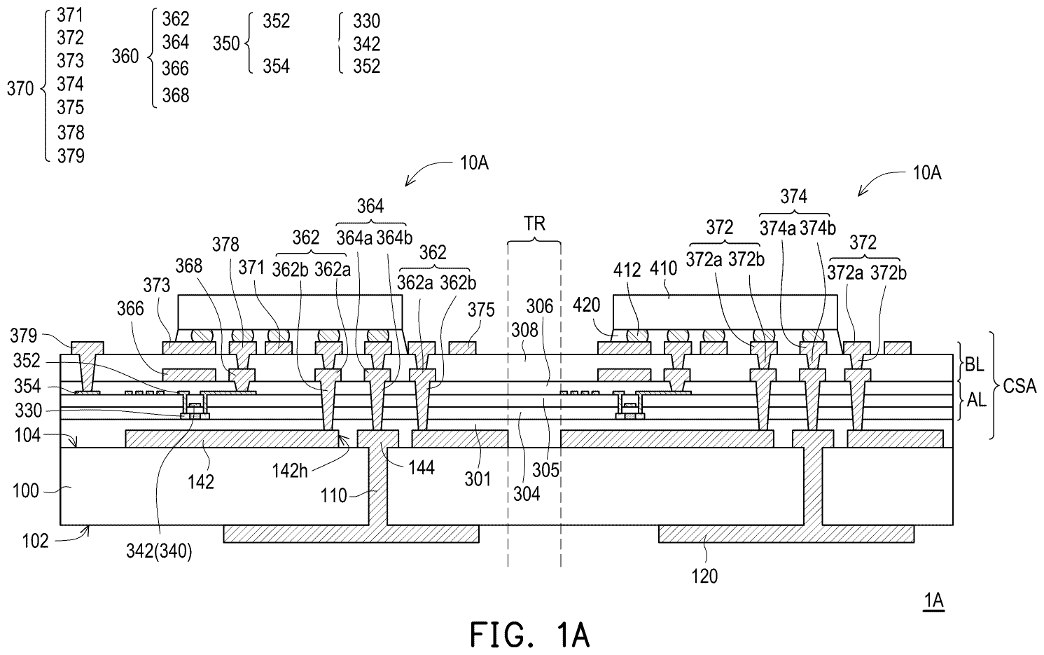

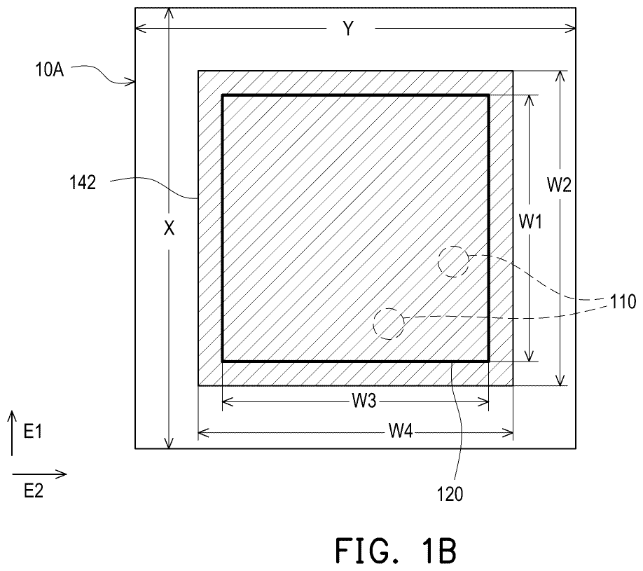

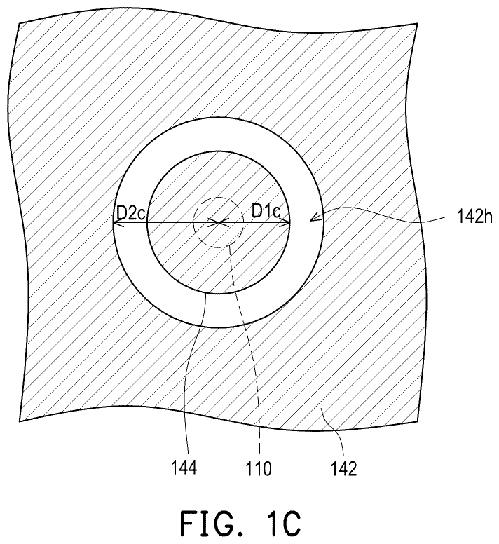

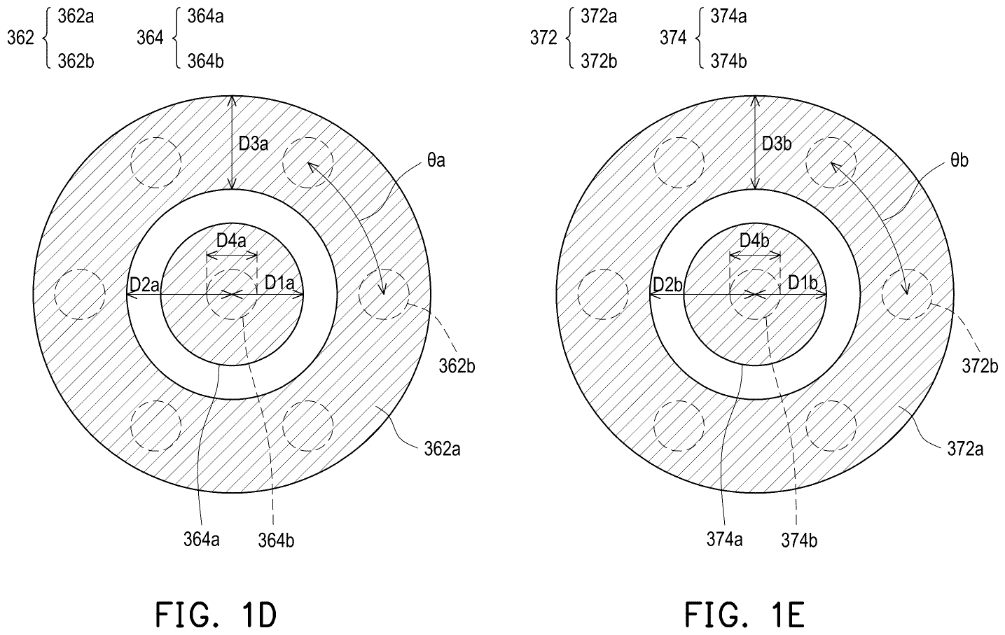

FIG. 1A is a schematic cross-sectional view of an antenna device 1A according to an embodiment of the disclosure. FIG. 1B is a schematic bottom view of an antenna unit 10A of the antenna device 1A in FIG. 1A, in which FIG. 1B shows an antenna electrode 120 and a ground electrode 142, and omits other structures. FIG. 1C is a schematic top view of the ground electrode 142 and a first antenna signal line 144 of the antenna device 1A in FIG. 1A. FIG. 1D and FIG. 1E are schematic top views of the shielding structure and the antenna signal line of the antenna device 1A in FIG. 1A.

Referring to FIG. 1A and FIG. 1B, the antenna device 1A includes a transparent substrate 100 and a plurality of antenna units 10A disposed on the transparent substrate. In some embodiments, a width X (or spacing) of the antenna unit 10A in a first direction E1 is 0.5λ₀ to 1λ₀, where λ0 is the wavelength of the wireless signal to be received or transmitted in the air. In some embodiments, the width X (or spacing) of the antenna unit 10A in the first direction E1 is equal to or not equal to a width Y (or spacing) of the antenna unit 10A in a second direction E2, where the first direction E1 is perpendicular to the second direction E2. For example, the width X and the width Y are both 0.5λ₀.

The transparent substrate 100 has a first surface 102 and a second surface 104 opposite to the first surface 102. In some embodiments, the transparent substrate 100 has a thickness of 0.1 mm to 1.1 mm. For example, the thickness of the transparent substrate 100 is 0.5 mm, 0.7 mm, or 1.1 mm.

In some embodiments, the material of the transparent substrate 100 includes glass, organic polymer, or other applicable materials. Examples of glass include Pyrex®, quartz (such as fused silica glass), soda-lime glass, aluminosilicate glass, borosilicate glass, aluminoborosilicate glass, or other suitable materials, or a combination of the above materials.

The antenna units 10A are arranged in an array to form an antenna array. A light-transmitting area TR is provided between adjacent antenna units 10A. In some embodiments, no conductive structure is provided in the light-transmitting area TR, but the disclosure is not limited thereto. In other embodiments, the light-transmitting area TR is provided with a metal grid or transparent conductive material that allows light to penetrate. In some embodiments, the transmittance of the light-transmitting area TR is greater than 50%.

Each antenna unit 10A includes an antenna electrode 120, a circuit structure CSA, and a chip 410. In addition, in the embodiment, each antenna unit 10A further includes a substrate through hole 110.

The antenna electrode 120 is disposed on the first surface 102 of the transparent substrate 100. In some embodiments, the transparent substrate 100 has a flat first surface 102. In other embodiments, the transparent substrate 100 optionally includes a groove recessed from the first surface 102. By disposing the antenna electrode 120 in the aforementioned groove, the surface flatness of the antenna device 1A may be improved. However, the aforementioned groove for accommodating the antenna electrode 120 may be omitted.

The substrate through hole 110 is located in the transparent substrate 100 and extends from the first surface 102 to the second surface 104. The substrate through hole 110 is connected to the antenna electrode 120.

The circuit structure CSA is located on the second surface 104 of the transparent substrate 100. In the embodiment, the circuit structure CSA includes a ground electrode 142, a first antenna signal line 144, a buffer layer 301, an active component layer AL, and a redistribution structure BL. In the embodiment, the substrate through hole 110 is electrically connected to the redistribution structure BL of the circuit structure CSA.

Referring to FIG. 1A and FIG. 1C, FIG. 1C only shows one of the first antenna signal lines 144 and the ground electrode 142 around it. The ground electrode 142 and the first antenna signal line 144 are located on the second surface 104 of the transparent substrate 100. The first antenna signal line 144 is connected to the antenna electrode 120 through the substrate through hole 110.

In the embodiment, the ground electrode 142 has an opening 142h. The first antenna signal line 144 is disposed in the opening 142h. The ground electrode 142 surrounds the first antenna signal line 144. The number of the first antenna signal lines 144 and the substrate through holes 110 in each antenna unit 10A can be adjusted according to requirements. In some embodiments, one or more first antenna signal lines 144 are connected to the same antenna electrode 120 through one or more substrate through holes 110.

In some embodiments, the first antenna signal line 144 is circular, and its radius D1c is 50 microns to 200 microns. In some embodiments, the opening 142h is circular and its radius D2c is 60 microns to 300 microns.

A width W2 of the ground electrode 142 in the first direction E1 is greater than a width W1 of the antenna electrode 120 in the first direction E1, as shown in FIG. 1B. Through such a design, interference caused by external signals to the antenna electrode 120 may be effectively reduced. In some embodiments, the width W2 of the ground electrode 142 in the first direction E1 is equal to or not equal to a width W4 of the ground electrode 142 in the second direction E2, and the width W1 of the antenna electrode 120 in the first direction E1 is equal to or not equal to a width W3 of the antenna electrode 120 in the second direction E2.

Referring to FIG. 1B, in some embodiments, a footprint A of the antenna unit 10A (i.e., the product of the width X and the width Y) is greater than a footprint A_{ground} (i.e., the product of the width W2 and the width W4) of the ground electrode 142. Moreover, the footprint A_{ground} of the ground electrode 142 is greater than a footprint A_{patch} of the antenna electrode 120 (i.e., the product of the width W1 and the width W3). In some embodiments, the footprint A_{ground} of the ground electrode 142 is greater than or equal to 1.2 times the footprint A_{patch} of the antenna electrode 120, so that the ground electrode 142 may better cover the antenna electrode 120. In some embodiments, the footprint A_{ground} of the ground electrode 142 is 100% to 35% of the footprint A of the antenna unit 10A, and the footprint A_{patch} of the antenna electrode 120 is 95% to 5% of the footprint A of the antenna unit 10A. In some embodiments, since the ground electrode 142 and the antenna electrode 120 may include a metal grid structure or a transparent conductive material, even if the footprint A_{ground} of the ground electrode 142 and the footprint A_{patch} of the antenna electrode 120 are close to the footprint A of the antenna unit 10A, the antenna device 1A may still maintain the light-transmitting area TR.

It should be noted that in the embodiment, the ground electrode 142 and the antenna electrode 120 both have rectangular outlines, but the disclosure is not limited thereto. The shapes of the ground electrode 142 and the antenna electrode 120 may be adjusted according to actual requirements.

In some embodiments, each of the material of the substrate through hole 110, the antenna electrode 120, the ground electrode 142, and the first antenna signal line 144 includes copper (Cu), aluminum (Al), gold (Au), silver (Ag), titanium (Ti), nickel (Ni), tungsten (W), conductive oxide (such as indium tin oxide, indium zinc oxide, etc.), or other suitable conductive materials, or a combination of the above materials.

The buffer layer 301 is located on the transparent substrate 100, the ground electrode 142, and the first antenna signal line 144. In some embodiments, the buffer layer 301 includes a transparent material, such as an organic material (such as polyimide, polyethylene terephthalate, epoxy resin, etc.), or an inorganic material (such as silicon nitride, silicon oxide, etc.), or a combination of the above materials. In some embodiments, the thickness of the ground electrode 142 and the first antenna signal line 144 is 5 microns to 10 microns. In order to achieve the planarization effect, the thickness of the buffer layer 301 is preferably 8 microns to 20 microns, and the thickness of the buffer layer 301 is not less than the thickness of the ground electrode 142. In order to achieve such a thickness and obtain the planarization effect, the buffer layer 301 is preferably made of an organic material.

In some embodiments, the buffer layer 301 has high transmittance and low dissipation factor (Df). For example, the transmittance of the buffer layer 301 for light with a wavelength of 400 nm to 800 nm is greater than or equal to 50%. In some embodiments, the dielectric constant (Dk) of the buffer layer 301 is less than 4, and the dissipation factor is less than 0.004. In some embodiments, the buffer layer 301 covers the first antenna signal line 144 for transmitting high-frequency radio frequency (RF) signals. Using the buffer layer 301 with a larger thickness and low dissipation factor is beneficial to reducing the loss of high-frequency signals.

The active component layer AL is located on the buffer layer 301. The active component layer AL includes a semiconductor layer 330, a gate dielectric layer 304, a first circuit layer 340, a first dielectric layer 305, a second circuit layer 350, and a second dielectric layer 306 formed in sequence. In some embodiments, the active component layer AL may also include more conductive layers and insulating layers. The disclosure does not limit the number of conductive layers and insulating layers in the active component layer AL.

The first circuit layer 340 includes a gate 342. The second circuit layer 350 includes a plurality of sources/drains 352 and a digital signal line 354. The gate 342 of the first circuit layer 340, the plurality of sources/drains 352 of the second circuit layer 350, and the semiconductor layer 330 are matched with each other to form an active component (e.g., a thin film transistor) T. In some embodiments, the active component T in the active component layer AL overlaps the ground electrode 142. In some embodiments, the active component T overlaps the antenna electrode 120.

In some embodiments, part of the second circuit layer 350 is electrically connected to part of the first circuit layer 340, but the disclosure is not limited thereto.

In some embodiments, the materials of the first circuit layer 340 and the second circuit layer 350 include copper (Cu), aluminum (Al), gold (Au), silver (Ag), titanium (Ti), nickel (Ni), tungsten (W), conductive oxides (such as indium tin oxide, indium zinc oxide, etc.), or other suitable materials, or a combination of the above materials. In some embodiments, the materials of the gate dielectric layer 304, the first dielectric layer 305, and the second dielectric layer 306 include organic polymers (such as polyimide, polyethylene terephthalate, etc.) or inorganic materials (such as silicon oxide, silicon nitride, silicon oxynitride, aluminum oxide, zirconium oxide, hafnium oxide, or other suitable materials, or a combination of the above materials).

The redistribution structure BL is located on the active component layer AL, and the active component layer AL, the buffer layer 301, and the ground electrode 142 are located between the redistribution structure BL and the second surface 104 of the transparent substrate 100. The redistribution structure BL includes a first redistribution layer 360, an insulating layer 308, and a second redistribution layer 370 formed in sequence. In some embodiments, the redistribution structure BL may also include more conductive layers and insulating layers. The disclosure does not limit the number of conductive layers and insulating layers in the redistribution structure BL.

In some embodiments, conductive holes pass through at least one of the insulating layer 308, the active component layer AL, and the buffer layer 301, and are used to electrically connect the first redistribution layer 360 and/or the second redistribution layer 370 to other conductive layers.

The first redistribution layer 360 includes a conductive feature 362, a conductive feature 364, a conductive feature 366, and a conductive feature 368. In the embodiment, the conductive feature 362, the conductive feature 364, the conductive feature 366, and the conductive feature 368 may be respectively referred to as a first shielding structure, a second antenna signal line, a shielding electrode, and a transmission line.

In the embodiment, the conductive feature 362 completely surrounds or partially surrounds the conductive feature 364 on the top surface of the second dielectric layer 306 (which may also be referred to as the insulating layer in some embodiments).

Referring to FIG. 1A and FIG. 1D, the conductive feature 364 (i.e., second antenna signal line) is electrically connected to the first antenna signal line 144. Specifically, the conductive feature 364 includes a connecting portion 364a extending on the top surface of the second dielectric layer 306 (which may also be referred to as the insulating layer in some embodiments) and a first conductive hole 364b located below the connecting portion 364a. The connecting portion 364a overlaps the chip 410. The first conductive hole 364b passes through at least one of the second dielectric layer 306, the first dielectric layer 305, the gate dielectric layer 304, and the buffer layer 301. In the embodiment, the first conductive hole 364b passes through the second dielectric layer 306, the first dielectric layer 305, the gate dielectric layer 304, and the buffer layer 301, and contacts the first antenna signal line 144.

In some embodiments, the connecting portion 364a is circular and its radius D1a is 50 microns to 200 microns. In some embodiments, an aperture D4a of the first conductive hole 364b is 60 microns to 200 microns.

The conductive feature 362 (i.e., first shielding structure) is electrically connected to the ground electrode 142. The conductive feature 362 includes a shielding portion 362a and a plurality of second conductive holes 362b located below the shielding portion 362a. The shielding portion 362a extends on the top surface of second dielectric layer 306 and completely surrounds the connecting portion 364a of the conductive feature 364. The plurality of second conductive holes 362b pass through at least one of the second dielectric layer 306, the first dielectric layer 305, the gate dielectric layer 304, and the buffer layer 301. In the embodiment, the second conductive holes 362b pass through the second dielectric layer 306, the first dielectric layer 305, the gate dielectric layer 304, and the buffer layer 301, and is electrically connected to the ground electrode 142. In the embodiment, the second conductive holes 362b are laterally separated from each other and arranged around the first conductive hole 364b, thereby reducing interference of external signals to the first conductive hole 364b.

In some embodiments, the shielding portion 362a is a ring surrounding the connecting portion 364a, in which a radius D2a of the circular space inside the shielding portion 362a is 60 microns to 300 microns, and a width D3a of the solid portion of the shielding portion 362a is 100 microns to 400 microns. In some embodiments, the aperture of the second conductive hole 362b is substantially the same as the aperture D4a of the first conductive hole 364b. In some embodiments, the distance between the center of the first conductive hole 364b and the center of the second conductive hole 362b and the center of the adjacent second conductive hole 362b may be as small as 110 microns, such as 110 microns to 500 microns.

In some embodiments, an angle θa between the line connecting the center of one second conductive hole 362b and the center of the first conductive hole 364b and the line connecting the center of another adjacent second conductive hole 362b and the center of the first conductive hole 364b is 30 degrees to 70 degrees.

The conductive feature 366 shields the active component T to reduce interference of other signals to the active component T. In some embodiments, the conductive feature 366 and the ground electrode 142 are both connected to a ground signal, for example. The conductive feature 368 is electrically connected to the active component T.

Referring to FIG. 1A, the second redistribution layer 370 includes a conductive feature 371, a conductive feature 372, a conductive feature 373, a conductive feature 374, a conductive feature 375, a conductive feature 378, and a conductive feature 379. In the embodiment, the conductive feature 371, the conductive feature 372, the conductive feature 373, the conductive feature 374, the conductive feature 375, the conductive feature 378, and the conductive feature 379 may be respectively referred to as a chip pad, a second shielding structure, a radio frequency signal input line, a third antenna signal line, a power line, a transmission line, and a pad.

In the embodiment, the conductive feature 372 completely surrounds or partially surrounds the conductive feature 374 on the top surface of the insulating layer 308.

Referring to FIG. 1A and FIG. 1E, the conductive feature 374 (i.e., third antenna signal line) is electrically connected to the conductive feature 364 (i.e., second antenna signal line). Specifically, the conductive feature 374 includes a connecting portion 374a extending on the top surface of the insulating layer 308 and a first conductive hole 374b located below the connecting portion 374a. The connecting portion 374a overlaps the chip 410. The first conductive hole 374b passes through the insulating layer 308 and contacts the conductive feature 364.

In some embodiments, the connecting portion 374a is circular and its radius D1b is 50 microns to 200 microns. In some embodiments, the first conductive hole 374b has an aperture D4b of 60 microns to 200 microns.

The conductive feature 372 (i.e., second shielding structure) is electrically connected to the conductive feature 362 (i.e., first shielding structure). The conductive feature 372 includes a shielding portion 372a and a plurality of second conductive holes 372b located below the shielding portion 372a. The shielding portion 372a extends on the top surface of the insulating layer 308 and completely surrounds the connecting portion 374a of the conductive feature 374. The plurality of second conductive holes 372b pass through the insulating layer 308 and are electrically connected to the conductive feature 362. In the embodiment, the second conductive holes 372b are laterally separated from each other and arranged around the first conductive hole 374b, thereby reducing interference of external signals to the first conductive hole 374b.

In some embodiments, the shielding portion 372a is a ring surrounding the connecting portion 374a, in which a radius D2b of the circular space inside the shielding portion 372a is 60 microns to 300 microns, and a width D3b of the solid portion of the shielding portion 372a is 100 microns to 400 microns. In some embodiments, the aperture of the second conductive hole 372b is substantially the same as the aperture D4b of the first conductive hole 374b. In some embodiments, the distance between the center of the first conductive hole 374b and the center of the second conductive hole 372b and the center of the adjacent second conductive hole 372b may be as small as 110 microns, such as 110 microns to 500 microns.

In some embodiments, an angle θb between the line connecting the center of one second conductive hole 372b and the center of the first conductive hole 374b and the line connecting the center of another adjacent second conductive hole 372b and the center of the first conductive hole 374b is 30 degrees to 70 degrees.

The conductive feature 378 is electrically connected to the active component T through the conductive feature 368. In some embodiments, the conductive feature 379 is used to connect to external circuit boards and components (not shown).

In some embodiments, the materials of the first redistribution layer 360 and the second redistribution layer 370 include copper (Cu), aluminum (Al), gold (Au), silver (Ag), titanium (Ti), nickel (Ni), tungsten (W), conductive oxides (such as indium tin oxide, indium zinc oxide, etc.), or other suitable materials, or a combination of the above materials. In the embodiment, each of the first redistribution layer 360 and the second redistribution layer 370 includes a seed layer and a metal layer formed thereon. The seed layer is, for example, formed by sputtering, electroless plating, or other suitable methods, and the metal layer is formed by electroplating.

In some embodiments, the material of the insulating layer 308 includes an organic material (such as polyimide, polyethylene terephthalate, epoxy resin, etc.), or an inorganic material (such as silicon nitride, silicon oxide, etc.), or a combination of the above materials. In some embodiments, the insulating layer 308 has high transmittance and low dissipation factor (Df). For example, the transmittance of the insulating layer 308 for light with a wavelength of 400 nm to 800 nm is greater than or equal to 50%. In some embodiments, the dielectric constant (Dk) of the insulating layer 308 is less than 4, and the dissipation factor is less than 0.004.

In some embodiments, the first redistribution layer 360 of the redistribution structure BL is disposed to transmit chip power signals and RF feed signals, and the second redistribution layer 370 is disposed to transmit ground signals. In some embodiments, the first circuit layer 340 and the second circuit layer 350 of the active component layer AL are disposed to transmit power signals and digital signals of the active component T. For example, the digital signal line 354 is disposed to transmit digital signals. Since the operating frequency of the above-mentioned digital signal is low, even if the film thickness of the gate dielectric layer 304, the first dielectric layer 305, and the second dielectric layer 306 in the active component layer AL is thin, it will not cause significant signal loss. In comparison, since the redistribution structure BL is used to transmit high-frequency RF signals, the insulating layer 308 in the redistribution structure BL needs to be thicker. Therefore, the thickness of the insulating layer 308 is greater than the respective thicknesses of the gate dielectric layer 304, the first dielectric layer 305, and the second dielectric layer 306. In some embodiments, the thickness of the digital signal line 354 is less than the thickness of the radio frequency signal input line (i.e., conductive feature 373).

The chip 410 is bonded to the second redistribution layer 370 of the redistribution structure BL. In some embodiments, the chip 410 is electrically connected to one or more of the conductive features 371, 372, 373, 374, 375, 378, and 379. In some embodiments, the chip 410 is bonded to the conductive features 371, 372, 373, 374, and 378 through conductive connection structures 412. The conductive connection structure 412 is, for example, solder, conductive glue, or other suitable structures. In some embodiments, the underfill material 420 is located between the chip 410 and the redistribution structure BL and surrounds the contact points (i.e., conductive connection structures 412) between the chip 410 and the redistribution structure BL. In some embodiments, the underfill material 420 may include a thermal interface material (TIM) to facilitate heat dissipation of the chip 410. For example, the thermal conductivity of the underfill material 420 is greater than 0.3 W/m K.

In some embodiments, the chip 410 includes a beamformer integrated circuit (BFIC) or other active/passive components. In some embodiments, the ground electrode 142, the antenna electrode 120, and the active component T are electrically connected to the chip 410. In some embodiments, the circuit including the active component T may be disposed in the active component layer AL, thereby reducing the number of circuits that need to be disposed in the chip 410. Therefore, the size of the chip 410 may be reduced.

Based on the above, the user can see the scene behind the antenna device 1A through the light-transmitting area TR of the antenna device 1A. In addition, the interference of other signals to the antenna signal may be reduced through the ground electrode 142, the conductive feature 362, and the conductive feature 372.

In some embodiments, the structures shown in FIG. 1D and FIG. 1E are referred to as concentric structures. Generally speaking, the position of the orthographic projection of the concentric structure onto the transparent substrate 100 needs to overlap the ground electrode 142, so that the concentric structure may be electrically connected to the ground electrode 142 through the conductive hole (such as the second conductive hole 362b). Therefore, the size of the ground electrode 142 may be limited to the concentric structure. If the area of the concentric structure is too large, the ground electrode 142 must be enlarged, so that each concentric structure may be electrically connected to the ground electrode 142 through the conductive hole. The area of the concentric structure will be limited by the apertures of the conductive holes (such as the first conductive holes 374b and 364b, and the second conductive holes 372b and 362b). Only by reducing the apertures of the conductive holes can the area of the concentric structure be reduced.

Table 1 shows the characteristics of various antenna units, in which each antenna electrode is fed signals by two substrate through holes, and each antenna electrode overlaps two concentric structures. In addition, in Table 1, the footprint A of each antenna unit is 5 mm×5 mm (i.e., the product of the width X and the width Y), and the footprint A_{patch} of each antenna electrode is 2.1 mm×2.1 mm (i.e. the product of the width W1 and the width W3). In Table 1, the orthographic projection area of the concentric structure is 0.02 to 0.4 times the footprint A_{patch} of the antenna electrode.

TABLE 1

| | Embodiment | Embodiment | Embodiment | Embodiment | Embodiment | Embodiment |
|---|---|---|---|---|---|---|
| | 1 | 2 | 3 | 4 | 5 | 6 |
| Aperture of conductive hole in | 200 | 200 | 100 | 80 | 60 | 60 |
| concentric structure (micron) | | | | | | |
| Antenna bandwidth (GHz) | 3.6 | 3.55 | 3.13 | 2.89 | 2.75 | 1.91 |
| Antenna gain (Gain) (dBi) | 4.58 | 4.56 | 4.57 | 4.57 | 4.57 | 4.56 |
| Antenna radiation efficiency (%) | 95.5 | 94.1 | 95.3 | 95.1 | 95.2 | 91.8 |
| Orthographic projection area of | 1.83 × 2 | 0.536 × 2 | 0.217 × 2 | 0.143 × 2 | 0.143 × 2 | 0.143 × 2 |
| concentric structure (mm²) | | | | | | |
| Orthographic projection area of | 0.83 | 0.243 | 0.098 | 0.065 | 0.065 | 0.065 |
| concentric structure/footprint of | | | | | | |
| antenna electrode (W1 × W3) | | | | | | |
| Footprint of ground electrode | 5 × 5 | 3.6 × 3.6 | 3.2 × 3.2 | 3.2 × 3.2 | 3.2 × 3.2 | 3.1 × 3.1 |
| (W2 × W4) (mm²) | | | | | | |
| Opening ratio of antenna unit | 0 | 47.4 | 58.2 | 58.2 | 58.2 | 61.5 |
| (%) | | | | | | |

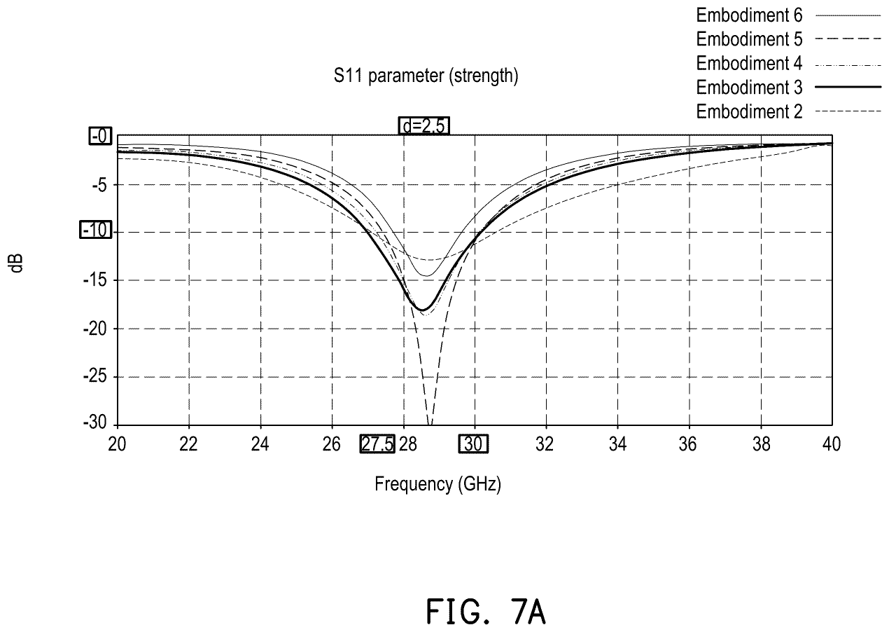

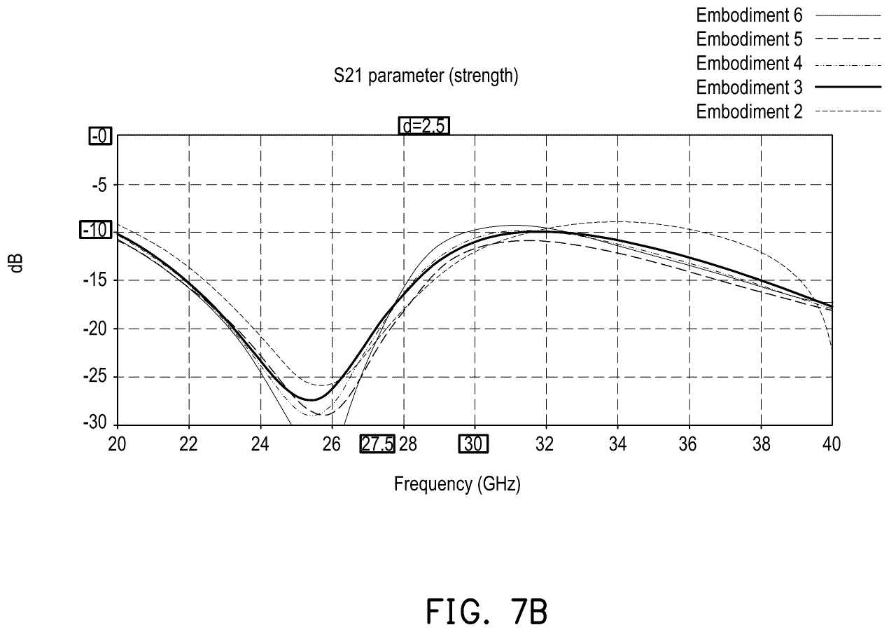

It can be known from Table 1 that in order to make the antenna bandwidth greater than or equal to 2.5 GHz, the footprint A_{ground} of the ground electrode is preferably more than 2.3 times the footprint A_{patch} (4.41 mm2) of the antenna electrode, for example, about 2.3 times to 3.1 times, as in Embodiment 2 to Embodiment 5. In addition, the footprint A_{ground} of the ground electrode in Embodiment 1 is equal to the footprint A of the antenna unit, resulting in the opening ratio of the antenna unit in Embodiment 1 being 0. FIG. 7A and FIG. 7B show the S11 parameter curves and S21 parameter curves of Embodiment 2 to Embodiment 6 in Table 1.

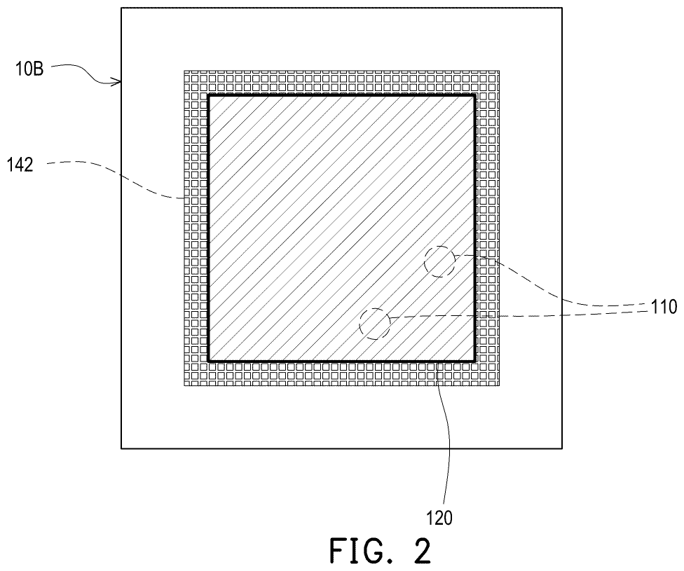

FIG. 2 is a schematic bottom view of an antenna unit 10B of an antenna device according to an embodiment of the disclosure. It must be noted here that the embodiment of FIG. 2 follows the reference numerals and a part of the contents of the embodiment of FIG. 1A to FIG. 1E, in which the same or similar reference numerals indicate the same or similar components, and repeated descriptions of the same technical contents are omitted. For the descriptions of the omitted parts, reference may be made to the previous embodiments, and will not be repeated here.

The difference between the antenna unit 10B in FIG. 2 and the antenna unit 10A in FIG. 1B lies in that: the ground electrode 142 of the antenna unit 10B has a mesh structure. Through such a design, the transmittance of the antenna unit 10B may be improved.

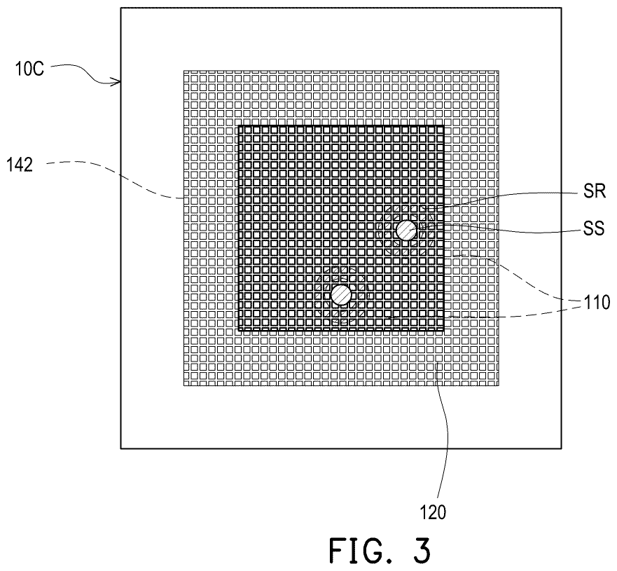

FIG. 3 is a schematic bottom view of an antenna unit 10C of an antenna device according to an embodiment of the disclosure. It must be noted here that the embodiment of FIG. 3 follows the reference numerals and a part of the contents of the embodiment of FIG. 2, in which the same or similar reference numerals indicate the same or similar components, and repeated descriptions of the same technical contents are omitted. For the descriptions of the omitted parts, reference may be made to the previous embodiments, and will not be repeated here.

The difference between the antenna unit 10C in FIG. 3 and the antenna unit 10B in FIG. 2 lies in that: in addition to the ground electrode 142 of the antenna unit 10C having a mesh structure, the antenna electrode 120 also has a mesh structure.

In the embodiment, the antenna signal is directly fed into the antenna electrode 120 through the substrate through hole 110, and the position where the antenna electrode 120 contacts the substrate through hole 110 has a solid structure SS. In addition, in order to reduce the interference of external signals to the antenna signal, the ground electrode 142 includes a solid ring structure SR surrounding the substrate through hole 110.

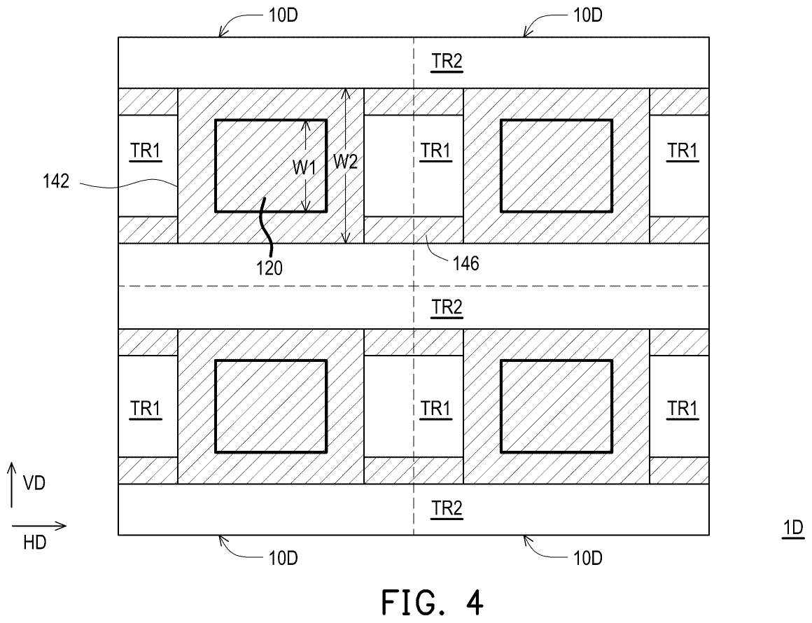

FIG. 4 is a schematic bottom view of an antenna device 1D according to an embodiment of the disclosure. It must be noted here that the embodiment of FIG. 4 follows the reference numerals and a part of the contents of the embodiment of FIG. 1A to FIG. 1E, in which the same or similar reference numerals indicate the same or similar components, and repeated descriptions of the same technical contents are omitted. For the descriptions of the omitted parts, reference may be made to the previous embodiments, and will not be repeated here.

The difference between the antenna device 1D in FIG. 4 and the antenna device 1A in FIG. 1A lies in that: in the antenna device 1D, the ground electrode 142 of adjacent antenna units 10D in an arrangement direction HD is electrically connected to each other through a connecting line 146. The ground electrode 142 of the adjacent antenna units 10D in an arrangement direction VD is separated from each other. The arrangement direction HD is perpendicular to the arrangement direction VD. In some embodiments, the ground electrode 142 is integrally formed with the connecting line 146.

In the embodiment, there is a first light-transmitting area TR1 surrounded by the ground electrode 142 and the connecting line 146 between the adjacent antenna units 10D in the arrangement direction HD, and there is a second light-transmitting area TR2 between two adjacent rows of antenna units in the arrangement direction VD.

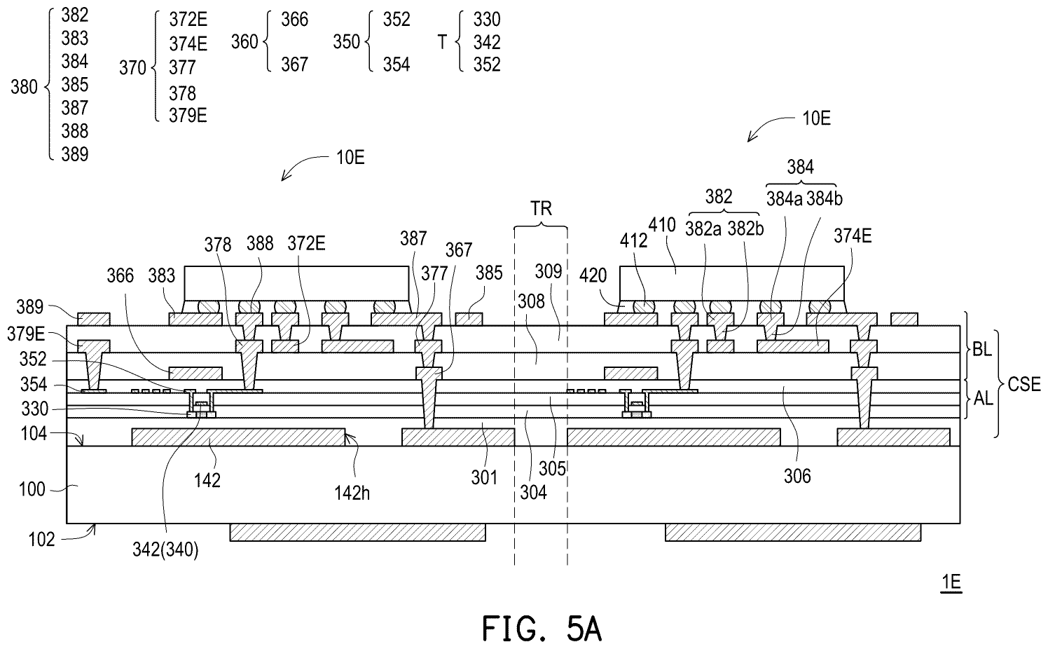

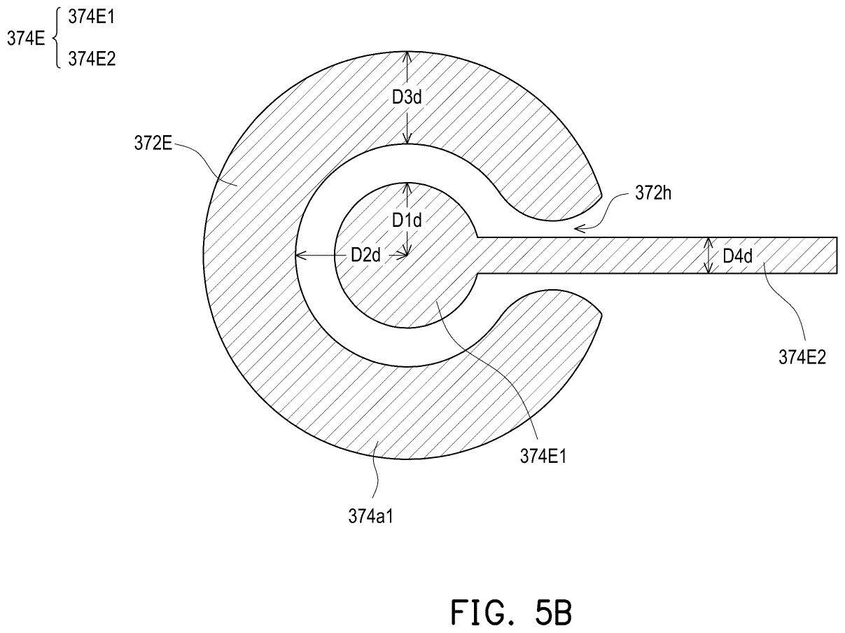

FIG. 5A is a schematic cross-sectional view of an antenna device 1E according to an embodiment of the disclosure. FIG. 5B is a schematic top view of the shielding structure of the antenna device 1E in FIG. 5A and its corresponding driving electrode. It must be noted here that the embodiment of FIG. 5A and FIG. 5B follows the reference numerals and a part of the contents of the embodiment of FIG. 1A to FIG. 1E, in which the same or similar reference numerals indicate the same or similar components, and repeated descriptions of the same technical contents are omitted. For the descriptions of the omitted parts, reference may be made to the previous embodiments, and will not be repeated here.

Referring to FIG. 5A and FIG. 5B, in the embodiment, each antenna unit 10E includes the antenna electrode 120, a circuit structure CSE, and the chip 410. In the embodiment, the antenna signal is not directly fed into the antenna electrode 120 through the substrate through hole. Instead, the antenna signal is radiatively coupled to the antenna electrode 120 through a conductive feature 374E (i.e., a drive electrode).

In the embodiment, the redistribution structure BL includes the first redistribution layer 360, the insulating layer 308, the second redistribution layer 370, an insulating layer 309, and a third redistribution layer 380 formed in sequence.

In some embodiments, the conductive hole passes through at least one of the insulating layer 309, the insulating layer 308, the active component layer AL, and the buffer layer 301, and is used to electrically connect the first redistribution layer 360, the second redistribution layer 370, and/or the third redistribution layer 380 to other conductive layers.

The first redistribution layer 360 includes the conductive feature 366 and a conductive feature 367. In the embodiment, the conductive feature 366 and the conductive feature 367 may be referred to as a shielding electrode and a first ground signal line respectively.

The conductive feature 366 shields the active component T to reduce interference of other signals to the active component T. The conductive feature 367 is electrically connected to the ground electrode 142 through a conductive hole passing through the active component layer AL and the buffer layer 301.

The second redistribution layer 370 includes a conductive feature 372E, the conductive feature 374E, a conductive feature 377, the conductive feature 378, and a conductive feature 379E. In the embodiment, the conductive feature 372E, the conductive feature 374E, the conductive feature 377, the conductive feature 378, and the conductive feature 379E may be respectively referred to as a first shielding structure, a driving electrode, a second ground signal line, a transmission line, and a signal line.

In the embodiment, the conductive feature 372E partially surrounds the conductive feature 374E on the top surface of the insulating layer 308.

Referring to FIG. 5A and FIG. 5B, the conductive feature 374E (i.e., driving electrode) includes a contact portion 374E1 and an electrode portion 374E2 connected to the contact portion 374E1. Both the contact portion 374E1 and the electrode portion 374E2 extend on the top surface of the insulating layer 308.

In some embodiments, the contact portion 374E1 is circular and its radius D1d is 50 microns to 200 microns. In some embodiments, a width D4d of the electrode portion 374E2 is 20 microns to 250 microns. The width of the contact portion 374E1 (i.e., twice the radius D1d) is greater than the width D4d of the electrode portion 374E2. The electrode portion 374E2 overlaps the antenna electrode 120 and the opening 142h of the ground electrode 142.

The conductive feature 372E (i.e., first shielding structure) is electrically connected to the ground signal. In the embodiment, the conductive feature 372E extends on the top surface of the insulating layer 308. The conductive feature 372E is annular with an opening 372h and partially surrounds the contact portion 374E1 on the top surface of the insulating layer 308. The electrode portion 374E2 extends on the top surface of the insulating layer 308 from the opening 372h to outside the conductive feature 372E.

The conductive feature 372E is an open ring partially surrounding the contact portion 374E1, in which a radius D2d of the circular space inside the conductive feature 372E is 60 microns to 300 microns, and a width D3d of the solid portion of the conductive feature 372E is 100 microns to 400 microns.

The conductive feature 377 is electrically connected to the ground electrode 142 through the conductive feature 367. The conductive feature 378 is electrically connected to the active component T. In some embodiments, the conductive feature 379E is electrically connected to the digital signal line 354.

Referring to FIG. 5A, the third redistribution layer 380 includes a conductive feature 382, a conductive feature 383, a conductive feature 384, a conductive feature 385, a conductive feature 387, a conductive feature 388, and a conductive feature 389. In the embodiment, the conductive feature 382, the conductive feature 383, the conductive feature 384, the conductive feature 385, the conductive feature 387, the conductive feature 388, and the conductive feature 389 may be respectively referred to as a second shielding structure, a radio frequency signal input line, an antenna signal line, a power line, a third ground signal line, a transmission line, and a pad.

In the embodiment, the conductive feature 382 partially surrounds the conductive feature 384 on the top surface of the insulating layer 309. In other embodiments, the conductive feature 382 completely surrounds the conductive feature 384 on the top surface of the insulating layer 309.

The conductive feature 384 (i.e., antenna signal line) is electrically connected to the conductive feature 374E (i.e., drive electrode). Specifically, the conductive feature 384 includes a connecting portion 384a extending on the top surface of the insulating layer 309 and a first conductive hole 384b located below the connecting portion 384a. The connecting portion 384a overlaps the chip 410. The first conductive hole 384b passes through the insulating layer 309 and contacts the contact portion 374E1 of the conductive feature 374E.

The conductive feature 382 (i.e., second shielding structure) is electrically connected to the conductive feature 372E (i.e., first shielding structure). The conductive feature 382 includes a shielding portion 382a and one or more second conductive holes 382b located below the shielding portion 382a. The shielding portion 382a extends on the top surface of the insulating layer 309. In some embodiments, the shielding portion 382a partially surrounds the connecting portion 384a of the conductive feature 384. The second conductive hole 382b passes through the insulating layer 309 and is electrically connected to the conductive feature 372E.

The conductive feature 387 is electrically connected to the ground electrode 142 through the conductive feature 377 and the conductive feature 367. The conductive feature 388 is electrically connected to the active component T through the conductive feature 378. In some embodiments, the conductive feature 389 is used to connect to external circuit boards and components (not shown).

In some embodiments, the materials of the first redistribution layer 360, the second redistribution layer 370, and the third redistribution layer 380 include copper (Cu), aluminum (Al), gold (Au), silver (Ag), titanium (Ti), nickel (Ni), tungsten (W), conductive oxides (such as indium tin oxide, indium zinc oxide, etc.), or other suitable materials, or a combination of the above materials. In the embodiment, each of the first redistribution layer 360, the second redistribution layer 370, and the third redistribution layer 380 include a seed layer and a metal layer formed thereon. The seed layer is, for example, formed by sputtering, electroless plating, or other suitable methods, and the metal layer is formed by electroplating.

In some embodiments, the materials of the insulating layer 308 and the insulating layer 309 include organic materials (such as polyimide, polyethylene terephthalate, epoxy resin, etc.), or inorganic materials (such as silicon nitride, silicon oxide, etc.), or a combination of the above materials. In some embodiments, the insulating layer 308 and the insulating layer 309 have high transmittance and low dissipation factor (Df). For example, the transmittance of the insulating layer 308 and the insulating layer 309 for light with a wavelength of 400 nm to 800 nm is greater than or equal to 50%. In some embodiments, the dielectric constant (Dk) of the insulating layer 308 and the insulating layer 309 is less than 4, and the dissipation factor is less than 0.004.

The chip 410 is bonded to the third redistribution layer 380 of the redistribution structure BL. In some embodiments, the chip 410 is electrically connected to one or more of the conductive feature 382, the conductive feature 383, the conductive feature 384, the conductive feature 385, the conductive feature 387, the conductive feature 388, and the conductive feature 389. In some embodiments, the chip 410 is bonded to the conductive features 382, 383, 384, 387, and 388 through the conductive connection structures 412.

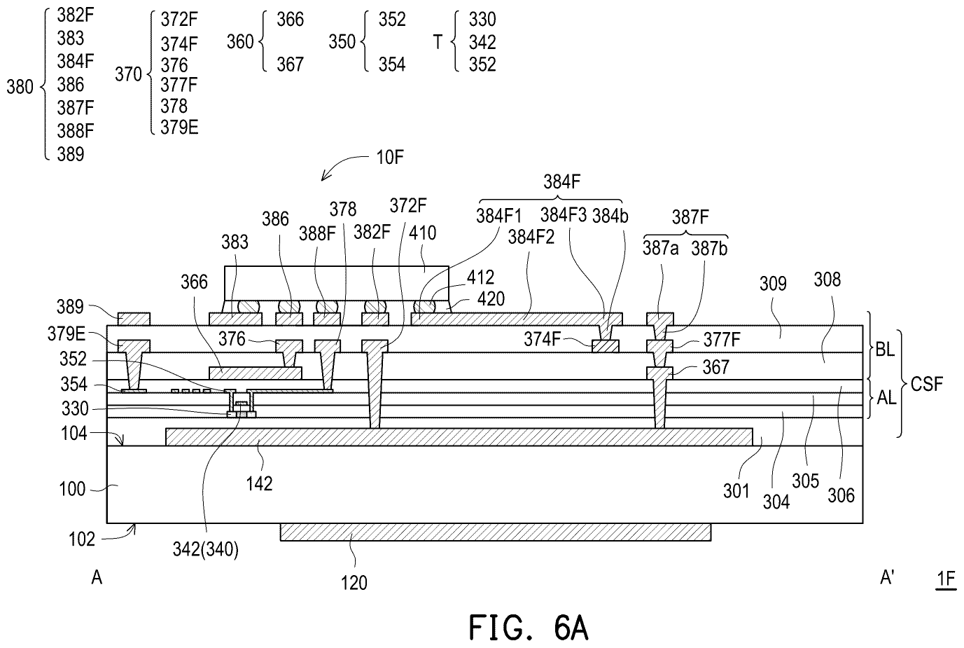

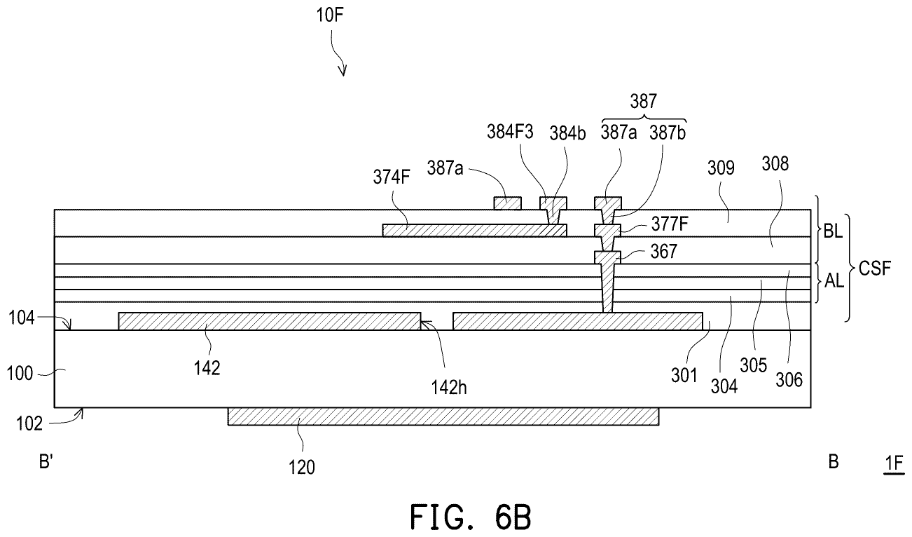

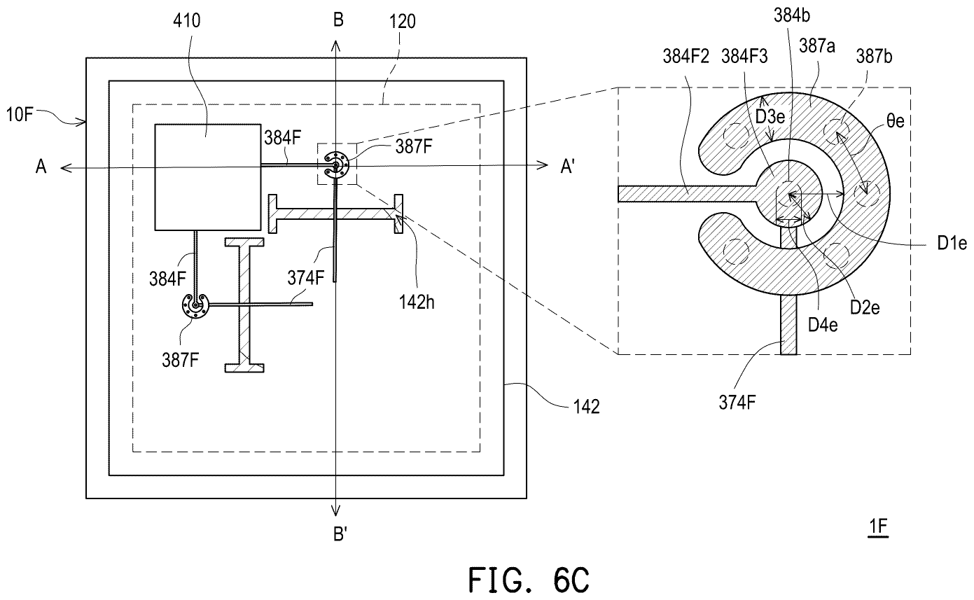

FIG. 6A and FIG. 6B are schematic cross-sectional views of an antenna device 1F along different sections according to an embodiment of the disclosure. FIG. 6C is a schematic top view of the antenna device 1F in FIG. 6A and FIG. 6B, in which FIG. 6C shows the chip 410, a conductive feature 382F, a conductive feature 384F, a conductive feature 374F, the ground electrode 142, and the antenna electrode 120, and other components are omitted. FIG. 6A and FIG. 6B are along a cross-section A-A′ and a cross-section B-B′ in FIG. 6C respectively. It must be noted here that the embodiment of FIG. 6A to FIG. 6C follows the reference numerals and a part of the contents of the embodiment of FIG. 5A and FIG. 5B, in which the same or similar reference numerals indicate the same or similar components, and repeated descriptions of the same technical contents are omitted. For the descriptions of the omitted parts, reference may be made to the previous embodiments, and will not be repeated here.

Referring to FIG. 6A to FIG. 6C, In the embodiment, an antenna unit 10F includes the antenna electrode 120, the circuit structure CSF, and the chip 410. In the embodiment, the antenna signal is not directly fed into the antenna electrode 120 through the substrate through hole. Instead, the antenna signal is radiatively coupled to the antenna electrode 120 through the conductive feature 374F (i.e., drive electrode). In some embodiments, the width of the chip 410 is less than the width of the ground electrode 142 and the width of the antenna electrode 120.

In the embodiment, the redistribution structure BL includes the first redistribution layer 360, the insulating layer 308, the second redistribution layer 370, the insulating layer 309, and the third redistribution layer 380 formed in sequence.

In some embodiments, the conductive hole passes through at least one of the insulating layer 309, the insulating layer 308, the active component layer AL, and the buffer layer 301, and is used to electrically connect the first redistribution layer 360, the second redistribution layer 370, and/or the third redistribution layer 380 to other conductive layers.

The first redistribution layer 360 includes the conductive feature 366 and the conductive feature 367. In the embodiment, the conductive feature 366 and the conductive feature 367 may be referred to as a shielding electrode and a first ground signal line respectively.

The conductive feature 366 shields the active component T to reduce interference of other signals to the active component T. The conductive feature 367 passes through the active component layer AL and the buffer layer 301 to be electrically connected to the ground electrode 142.

The second redistribution layer 370 includes a conductive feature 372F, the conductive feature 374F, a conductive feature 376, a conductive feature 377F, the conductive feature 378, and the conductive feature 379E. In the embodiment, the conductive feature 372F, the conductive feature 374F, the conductive feature 376, the conductive feature 377F, the conductive feature 378, and the conductive feature 379E may be respectively referred to as second ground signal line, a driving electrode, a third ground signal line, a fourth ground signal line, a transmission line, and a signal line.

In the embodiment, the conductive feature 372F is electrically connected to the ground electrode 142 through a conductive hole passing through the insulating layer 308, the active component layer AL, and the buffer layer 301.

The conductive feature 374F (i.e., drive electrode) extends on the top surface of the insulating layer 308 and overlaps the antenna electrode 120 and the opening 142h of the ground electrode 142. In the embodiment, each antenna unit 10F includes two conductive features 374F, and each ground electrode 142 includes two openings 142h. The two conductive features 374F overlap the two openings 142h respectively. In some embodiments, the conductive feature 374F may have the same shape as the conductive feature 374E shown in FIG. 5A and FIG. 5B, but the disclosure is not limited thereto.

The conductive feature 376 is electrically connected to the conductive feature 366.

The conductive feature 377F is electrically connected to the conductive feature 367. In some embodiments, the conductive feature 377F may serve as a shielding structure and may partially surround the drive electrode, such as the conductive feature 372E in FIG. 5B.

The conductive feature 378 is electrically connected to the active component T. In some embodiments, the conductive feature 379E is electrically connected to the digital signal line 354.

The third redistribution layer 380 includes the conductive feature 382F, the conductive feature 383, the conductive feature 384F, a conductive feature 386, a conductive feature 387F, a conductive feature 388F, and the conductive feature 389. In the embodiment, the conductive feature 382F, the conductive feature 383, the conductive feature 384F, the conductive feature 386, the conductive feature 387F, the conductive feature 388F, and the conductive feature 389 may be respectively referred to as a first shielding structure, a radio frequency signal input line, an antenna signal line, a first pad, a second shielding structure, a second pad, and a third pad.

In some embodiments, the conductive feature 382F partially surrounds the conductive feature 384F on the top surface of the insulating layer 309 and underneath the chip 410, similar to the conductive feature 372 and the conductive feature 374 in FIG. 5B.

The conductive feature 384F (i.e., antenna signal line) is electrically connected to the conductive feature 374F (i.e., drive electrode). Specifically, the conductive feature 384F includes a contact portion 384F1 extending on the top surface of the insulating layer 309, a conductive line portion 384F2, a connecting portion 384F3, and a first conductive hole 384b located below the connecting portion 384F3. The contact portion 384F1, the conductive line portion 384F2, and the connecting portion 384F3 are connected in sequence. The contact portion 384F1 overlaps the chip 410. The conductive line portion 384F2 extends from below the chip 410 along the top surface of the insulating layer 309 in a direction away from the chip 410. The connecting portion 384F3 does not overlap the chip 410. The first conductive hole 384b passes through the insulating layer 309 and contacts the conductive feature 374F.

In some embodiments, the connecting portion 384F3 is circular, and its radius D2e is 60 microns to 300 microns. The width of the connecting portion 384F3 (i.e., twice the radius D2e) is greater than the width of the conductive line portion 384F2. In some embodiments, an aperture D4e of the first conductive hole 384b is 60 microns to 200 microns.

The conductive feature 387F (i.e., second shielding structure) is electrically connected to the conductive feature 377F. The conductive feature 387F includes a shielding portion 387a and one or more second conductive holes 387b located below the shielding portion 387a. The shielding portion 387a extends on the top surface of the insulating layer 309. In some embodiments, the shielding portion 387a partially surrounds the connecting portion 384F3 of the conductive feature 384. The second conductive hole 387b passes through the insulating layer 309 and is electrically connected to the conductive feature 377F.

In some embodiments, the shielding portion 387a is an open ring partially surrounding the connecting portion 384F3, in which a radius D1e of the circular space inside the shielding portion 387a is 50 microns to 200 microns, and a width D3e of the solid portion of the shielding portion 387a is 100 microns to 400 microns.

In some embodiments, an angle θe between the line connecting the center of one second conductive hole 387b and the center of the first conductive hole 384b and the line connecting the center of another adjacent second conductive hole 387b and the center of the first conductive hole 384b is 30 degrees to 70 degrees.

The conductive feature 387F is electrically connected to the ground electrode 142 through the conductive feature 377F and the conductive feature 367.

The chip 410 is bonded to the third redistribution layer 380 of the redistribution structure BL. In some embodiments, the chip 410 is electrically connected to one or more of the conductive feature 382F, the conductive feature 383, the conductive feature 384F, the conductive feature 386, the conductive feature 387F, the conductive feature 388F, and the conductive feature 389. In some embodiments, the chip 410 is bonded to the conductive features 382F, 383, 384F, 386, and 388F through the conductive connection structures 412.

To sum up, the antenna device of the disclosure is provided with the light-transmitting area between the antenna units, thereby allowing the user to see the scene behind the antenna device through the antenna device. In addition, through the design of the ground electrode and the shielding structure, the interference of external signals to the antenna signal may be reduced.

What is claimed is:

1. An antenna device, comprising:
a transparent substrate, having a first surface and a second surface opposite to the first surface; and
a plurality of antenna units, disposed on the transparent substrate, wherein there is a light-transmitting area between adjacent antenna units, each of the antenna units comprising:
an antenna electrode, disposed on the first surface of the transparent substrate;
a ground electrode, disposed on the second surface of the transparent substrate, wherein a width of the ground electrode in a first direction is greater than a width of the antenna electrode in the first direction;
a redistribution structure, coupled to the antenna electrode, wherein the ground electrode is located between the redistribution structure and the transparent substrate; and
a chip, bonded to the redistribution structure.

2. The antenna device according to claim 1, wherein each of the antenna units further comprises an active component layer, the active component layer is located between the redistribution structure and the transparent substrate, and at least one active component in the active component layer overlaps the ground electrode.

3. The antenna device according to claim 1, wherein each of the antenna units further comprises:
a substrate through hole, located in the transparent substrate, wherein the substrate through hole is connected to the antenna electrode, and the substrate through hole is electrically connected to the redistribution structure.

4. The antenna device according to claim 1, wherein the redistribution structure comprises:
a shielding structure; and
an antenna signal line, wherein the shielding structure completely surrounds or partially surrounds the antenna signal line on a top surface of an insulating layer.

5. The antenna device according to claim 4, wherein the antenna signal line comprises:
a connecting portion; and
a conductive line portion, connected to the connecting portion, wherein a width of the conductive line portion is less than a width of the connecting portion.

6. The antenna device according to claim 5, wherein the antenna signal line further comprises:
a first conductive hole, located below the connecting portion, wherein the conductive line portion extends from below the chip along the top surface of the insulating layer in a direction away from the chip, and the connecting portion does not overlap the chip.

7. The antenna device according to claim 6, wherein the shielding structure comprises:
a shielding portion, wherein the shielding portion is annular with an opening, and partially surrounds the connecting portion of the antenna signal line on the top surface of the insulating layer, and the conductive line portion extends from the opening into the shielding portion on the top surface of the insulating layer; and
a plurality of second conductive holes, located below the shielding portion, and electrically connected to the ground electrode.

8. The antenna device according to claim 7, wherein the second conductive holes are laterally separated from each other, and are arranged around the first conductive hole.

9. The antenna device according to claim 6, wherein the redistribution structure comprises:
a driving electrode, electrically connected to the first conductive hole, and coupled to the antenna electrode.

10. The antenna device according to claim 4, wherein the antenna signal line comprises:
a connecting portion, overlapping the chip; and
a first conductive hole, located below the connecting portion.

11. The antenna device according to claim 10, wherein the shielding structure comprises:
a shielding portion, completely surrounding the connecting portion of the antenna signal line on the top surface of the insulating layer; and
a plurality of second conductive holes, located below the shielding portion, and electrically connected to the ground electrode, wherein the second conductive holes are laterally separated from each other, and arranged around the first conductive hole.

12. The antenna device according to claim 1, wherein the ground electrode has a mesh structure.

13. The antenna device according to claim 1, wherein the antenna electrode has a mesh structure.

14. The antenna device according to claim 1, further comprising:
a connecting line, wherein the ground electrode of two adjacent ones of the antenna units is electrically connected to each other through the connecting line.

15. The antenna device according to claim 1, wherein a width of the chip is less than the width of the ground electrode.

16. The antenna device according to claim 1, wherein a width of the chip is less than the width of the antenna electrode.

17. The antenna device according to claim 1, wherein the redistribution structure comprises:
a shielding structure; and
a driving electrode, wherein the driving electrode comprises:
a contact portion; and
an electrode portion, connected to the contact portion, wherein a width of the contact portion is greater than a width of the electrode portion, the shielding structure is annular with an opening, the shielding structure partially surrounds the contact portion on a top surface of an insulating layer, and the electrode portion extends from the opening to outside the shielding structure on the top surface of the insulating layer.
